(19) United States
(12) Patent Application Publication
(10) Pub. No.: US 2026/0119829 A1
(43) Pub. Date: Apr. 30, 2026

(54) INFORMATION PROCESSING APPARATUS AND IMAGE FORMING APPARATUS

(71) Applicants: Saki TAJIMA, Kanagawa (JP); Jun HITOSUGI, Tokyo (JP); Mizuho KIMURA, Kanagawa (JP)

(72) Inventors: Saki TAJIMA, Kanagawa (JP); Jun HITOSUGI, Tokyo (JP); Mizuho KIMURA, Kanagawa (JP)

(73) Assignee: Ricoh Company, Ltd., Tokyo (JP)

(21) Appl. No.: 19/335,883

(22) Filed: Sep. 22, 2025

(30) Foreign Application Priority Data
Oct. 30, 2024 (JP) 2024-190900

(51) Int. Cl. G06K 7/14; H04N 1/32

(52) U.S. Cl. CPC G06K 7/1417; H04N 1/32133; H04N 2201/327

(57) ABSTRACT

An information processing apparatus includes circuitry. The circuitry stores, in a memory, historical information related to first communication originating from a terminal apparatus and based on first connection information. The circuitry transmits, based on the historical information, either a first content specified by the first connection information or a second content specified by second connection information to the terminal apparatus in response to second communication originating from the terminal apparatus and based on the second connection information.

### CROSS-REFERENCE TO RELATED APPLICATION

This patent application is based on and claims priority pursuant to 35 U.S.C. § 119(a) to Japanese Patent Application No. 2024-190900, filed on Oct. 30, 2024, in the Japan Patent Office, the entire disclosure of which is hereby incorporated by reference herein.

### BACKGROUND

### Technical Field

The present disclosure relates to an information processing apparatus and an image forming apparatus.

### Related Art

A technique has been developed to provide content tailored to a terminal apparatus in response to communication from the terminal apparatus.

### SUMMARY

The present disclosure described herein provides an information processing apparatus including circuitry. The circuitry stores, in a memory, historical information related to first communication originating from a terminal apparatus and based on first connection information. The circuitry transmits, based on the historical information, either a first content specified by the first connection information or a second content specified by second connection information to the terminal apparatus in response to second communication originating from the terminal apparatus and based on the second connection information.

The present disclosure described herein provides an information processing apparatus including circuitry. The circuitry stores, in a memory, historical information related to first communication originating from a terminal apparatus and based on first connection information. The circuitry transmits a first content specified by the first connection information in response to the first communication originating from the terminal apparatus and based on the first connection information. The circuitry transmits, based on the historical information, either a second content or a third content different from the first content and the second content to the terminal apparatus in response to second communication originating from the terminal apparatus and based on second connection information.

The present disclosure described herein provides an image forming apparatus including an image forming device to form a first code visible under invisible light and a second code visible under visible light on a same image forming medium. The first code is inside an area where the second code is formed.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of a content providing system;

FIG. 2 is a schematic diagram illustrating a configuration of a copier;

FIG. 3A is a schematic diagram illustrating a toner image formed by a copier;

FIG. 3B is a schematic diagram illustrating the toner layers of the toner image of FIG. 3A;

FIG. 4 is a block diagram illustrating a hardware configuration of an information processing apparatus;

FIG. 5 is a block diagram illustrating a hardware configuration of a terminal apparatus;

FIG. 6 is a diagram illustrating a printed material;

FIG. 7A is a diagram illustrating a usage scene of a printed material under visible light;

FIG. 7B is a diagram illustrating a usage scene of a printed material under invisible light;

FIG. 8 is a block diagram illustrating a functional configuration of a content providing system;

FIG. 9 is a diagram illustrating a customer information table;

FIG. 10 is a diagram illustrating a connection information table;

FIG. 11 is a diagram illustrating a historical information table;

FIG. 12 is a flowchart of an image forming method;

FIG. 13 is a flowchart of a content providing method;

FIG. 14 is a flowchart of a content providing method according to a first modification;

FIG. 15 is a flowchart of a content providing method according to a second modification; and

FIG. 16 is a flowchart of a content providing method according to a third modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described in detail below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

An information processing system that provides content to a terminal apparatus operated by a user is described below. The information processing system may be referred to as a “content providing system” in the following description. In the content providing system, an information processing apparatus that manages content electronically provides content to a terminal apparatus via a communication network.

The content may be any content that can be electronically provided via a communication network. For example, the content may include at least one of a web page, image data, audio data, and document data. The image data may include a still image or a moving image. The document data may include a portable document format (PDF), a word processor format, a spreadsheet format, and a presentation format.

A technique has been developed to connect to an information processing apparatus that manages desired content by reading a two-dimensional code encoding connection information, such as a uniform resource locator (URL). In this type of technique, communication with a terminal apparatus may be redirected to appropriate content based on information specific to the terminal apparatus as the connection source. Such information may include, for example, the language settings or location data of the terminal apparatus.

The information specific to the terminal apparatus may include information that requires permission before being transmitted externally. In this case, when the user refuses to transmit the information externally, the information specific to the terminal apparatus may not be obtained. As a result, appropriate content may not be provided. It may be desired to control the content to be provided based on a predetermined condition that is not related to the information specific to the terminal apparatus. As an example, when content suitable for the progress of a game using position information is desired to be provided, appropriate content may not be provided based on the position information alone.

The present embodiment is directed to controlling content to be transmitted to a terminal apparatus without using information specific to the terminal apparatus. In one aspect, according to the present embodiment, such control of the content to be transmitted to the terminal apparatus without using the information specific to the terminal apparatus allows appropriate content to be provided to the terminal apparatus without the information specific to the terminal apparatus.

### Overall Configuration of Content Providing System

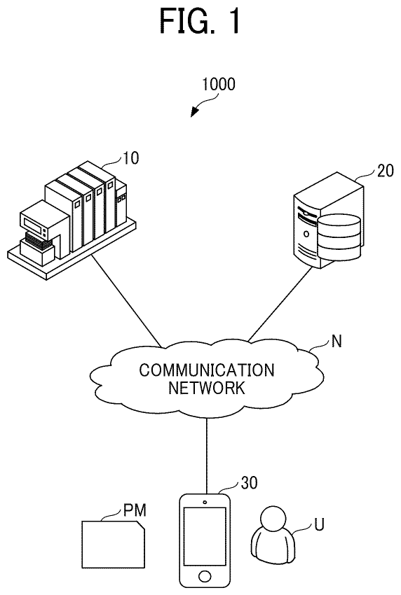

An overall configuration of a content providing system is described below with reference to FIG. 1. FIG. 1 is a schematic diagram illustrating an overall configuration of a content providing system.

As illustrated in FIG. 1, a content providing system 1000 includes an image forming apparatus 10, an information processing apparatus 20, and a terminal apparatus 30. The image forming apparatus 10, the information processing apparatus 20, and the terminal apparatus 30 are connected to a communication network N. The communication network N enables communication between the connected apparatuses.

The communication network N is, for example, a wired communication network, such as the Internet, a local area network (LAN), or a wide area network (WAN). The communication network N may include not only wired communication networks, but also a wireless communication networks, such as a wireless LAN or a short-range wireless communication network, and may further include mobile communication networks, such as Worldwide Interoperability for Microwave Access (WiMAX), Long Term Evolution (LTE), or the fifth generation (5G).

The image forming apparatus 10 is an example of an electronic apparatus that forms an image on an image forming medium. The image forming apparatus 10 may be an electrostatic recording apparatus that applies toner to a print sheet, which is an example of the image forming medium, by the action of static electricity. The image forming apparatus 10 may be a liquid discharge apparatus that discharges liquid, such as ink, to apply the liquid to a print sheet. The image forming apparatus 10 may be, for example, a laser printer, an inkjet printer, or an electrostatic copier.

The image forming apparatus 10 has the function of forming an invisible image and a visible image on an image forming medium. The image forming apparatus 10 may produce a printed material PM on which at least one of an invisible image and a visible image is formed. The printed material PM may be referred to as a printed matter. The image forming apparatus 10 produces the printed material PM on which an image, such as a two-dimensional code, including connection information, such as a URL, to the information processing apparatus 20 is formed. The printed material PM produced by the image forming apparatus 10 is distributed to a user U who operates the terminal apparatus 30.

The information processing apparatus 20 is an example of an information processing apparatus that provides content to the terminal apparatus 30. The information processing apparatus 20 may be, for example, a computer such as a personal computer, a workstation, or a server. The information processing apparatus 20 receives the connection from the terminal apparatus 30. The information processing apparatus 20 transmits (provides) content to the connected terminal apparatus 30.

The terminal apparatus 30 is an example of an information processing terminal operated by the user U. The terminal apparatus 30 may be, for example, a computer such as a personal computer, a smartphone, or a tablet device. The terminal apparatus 30 reads an image formed on the printed material PM by the image forming apparatus 10, and initiates communication with the information processing apparatus 20 based on the connection information included in the image. The terminal apparatus 30 presents, to the user U, the content provided by the information processing apparatus 20 through communication with the information processing apparatus 20.

The information processing apparatus 20 and the terminal apparatus 30 are not limited to computers, and may be any apparatuses having a communication function. Each of the information processing apparatus 20 and the terminal apparatus 30 may be, for example, an output device such as a projector (PJ), an interactive whiteboard (IWB; an electronic whiteboard with blackboard functionality and mutual communication capability), or digital signage; a head-up display (HUD) device; an industrial machine; an imaging (image-capturing) device; a sound-collecting device; a medical device; a networked home appliance; an automobile (connected car); a laptop personal computer (PC); a mobile phone; a smartphone; a tablet terminal; a game console; a personal digital assistant (PDA); a digital camera; a wearable PC; or a desktop PC.

### Hardware Configuration of Image Forming Apparatus

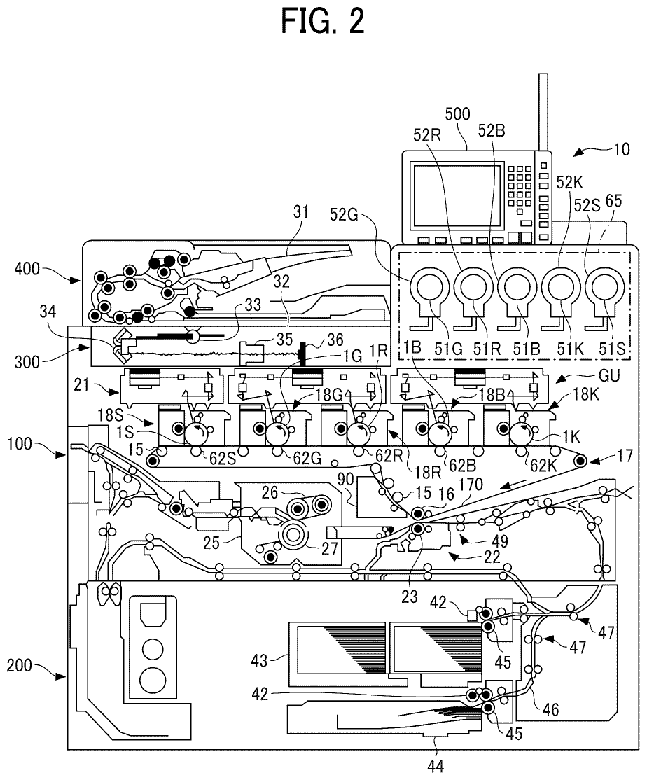

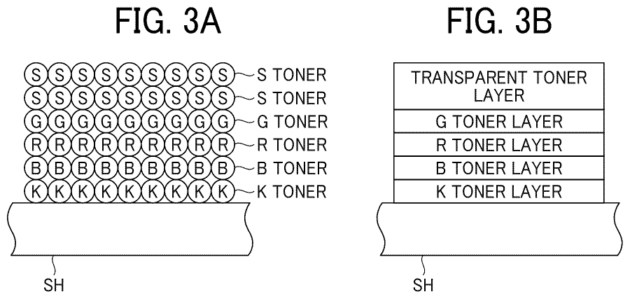

The hardware configuration of the image forming apparatus 10 is described below with reference to FIGS. 2, 3A, and 3B. An example of the image forming apparatus 10 is a tandem color laser copier in which multiple photoconductors are aligned in parallel. The tandem color laser copier may be referred to simply as a “copier” in the following description.

A basic configuration of the copier is described below with reference to FIG. 2. FIG. 2 is a schematic diagram illustrating a configuration of the copier. The copier is an electrophotographic image forming apparatus and includes a printer 100, a feeding device 200, a scanner 300, and an automatic document feeder (ADF) 400. The image forming apparatus 10 may be any printing apparatus having a printing function for outputting printed materials, and may include only a portion of the above-described components. Therefore, the image forming apparatus is not limited by its designation.

The printer 100 includes an image forming unit GU. The image forming unit GU includes five developing stations 18S, 18G, 18R, 18B, and 18K that form images in colors of special color(S), invisible green (G), invisible red (R), invisible blue (B), and black (K) as a key plate, respectively. Suffixes S, G, R, B, and K appended to the numeral “18” of reference signs 18S, 18G, 18R, 18B, and 18K indicate that the developing stations 18S, 18G, 18R, 18B, and 18K are components for the colors of special color, invisible green, invisible red, invisible blue, and black, respectively. The same applies to other reference signs used in the following description. In the following description, the suffixes S, G, R, B, and K may denote the colors of special color, invisible green, invisible red, invisible blue, and black, respectively. To simplify the description, these suffixes may be omitted unless necessary.

The special color is a generic term for any color different from the colors of invisible green, invisible red, invisible blue, and black. The black refers to a black color visible under visible light. The special color refers to a special color visible under visible light. The printer 100 mounts cyan (C) toner, magenta (M) toner, and yellow (Y) toner as colorants for visible colors, and also mounts metallic toner (gold, silver, or copper), fluorescent color toner, or light color toner to form or print visible images. A visible image and an invisible image may either be printed at once or layered in two separate printing processes.

In addition to the developing stations 18S, 18G, 18R, 18B, and 18K, for example, an optical writing device 21, an intermediate transfer device 17, a secondary transfer device 22, a registration roller pair 49, and a fixing device 25 employing a belt fixing system are disposed in a housing of the printer 100.

The optical writing device 21 includes a light source, a polygon mirror, an f-θ lens, and a reflection mirror. The optical writing device 21 irradiates the surfaces of photoconductors 1S, 1G, 1R, 1B, and 1K with laser light according to image data.

The developing stations 18S, 18G, 18R, 18B, and 18K include the drum-shaped photoconductors 1S, 1G, 1R, 1B, and 1K, respectively. Each of the developing stations 18S, 18G, 18R, 18B, and 18K further includes a charging roller, a developing device, a drum cleaning device, and an electrostatic-charge removing lamp as an electrostatic-charge remover.

The surface of the photoconductor 1S in the developing station 18S for S (special color) is uniformly charged by the charging roller serving as charging means. The charged surface of the photoconductor 1S is irradiated with laser light modulated and deflected by the optical writing device 21. Then, the potential of the irradiated portion (exposed portion) of the surface of the photoconductor 1S is attenuated. Due to this attenuation, an electrostatic latent image for S is formed on the surface of the photoconductor 1S. The electrostatic latent image for S thus formed is developed by the developing device serving as developing means to be an S toner image.

The S toner image formed on the photoconductor 1S for S is primarily transferred onto an intermediate transfer belt 170. After the primary transfer, the residual toner is removed by the drum cleaning device from the surface of the photoconductor 1S.

In the developing station 18S for S, the photoconductor 1S cleaned by the drum cleaning device is discharged by the electrostatic-charge remover. The photoconductor 1S is then uniformly charged by the charging roller and returns to the initial state. The above-described series of processes is similarly performed in the developing stations 18G, 18R, 18B and 18K for the colors of G, R, B, and K.

The intermediate transfer device 17 includes the endless intermediate transfer belt 170 and a belt cleaning device 90. The intermediate transfer device 17 further includes driving rollers 15, a secondary transfer backup roller 16, and five primary transfer bias rollers 62S, 62G, 62R, 62B, and 62K.

The endless intermediate transfer belt 170 is stretched taut around multiple tension rollers, such as the driving rollers 15, disposed inside the loop of the intermediate transfer belt 170. The endless intermediate transfer belt 170 is moved along a continuous loop in a clockwise direction in FIG. 2 by the rotation of the driving rollers 15 driven by a belt driving motor.

The primary transfer bias rollers 62S, 62G, 62R, 62B, and 62K for S, G, R, B, and K are disposed so as to contact the back surface (inner circumferential face) of the intermediate transfer belt 170. A primary transfer bias output from a power source is applied to each of the primary transfer bias rollers 62S, 62G, 62R, 62B, and 62K. The primary transfer bias rollers 62S, 62G, 62R, 62B, and 62K press the intermediate transfer belt 170 toward the photoconductors 1S, 1G, 1R, 1B, and 1K, respectively, from the back surface of the intermediate transfer belt 170. As a result, primary transfer nips for S, G, R, B, and K are formed between the front surface (outer circumferential face) of the intermediate transfer belt 170 and the photoconductors 1S, 1G, 1R, 1B, and 1K in contact with the front surface of the intermediate transfer belt 170. Due to the influence of the primary transfer bias, primary transfer electric fields are generated at the primary transfer nips between the photoconductors 1S, 1G, 1R, 1B, and 1K and the primary transfer bias rollers 62S, 62G, 62R, 62B, and 62K.

The S toner image formed on the photoconductor 1S for S is primarily transferred onto the intermediate transfer belt 170 by the influence of the primary transfer electric field and the nip pressure. A G toner image, an R toner image, a B toner image, and a K toner image respectively formed on the photoconductors 1G, 1R, 1B, and 1K for G, R, B, and K are sequentially superimposed and primarily transferred onto the S toner image. The primary transfer by the superimposition results in the formation of a multicolor toner image on the intermediate transfer belt 170.

The multicolor toner image formed on the intermediate transfer belt 170 is secondarily transferred onto a recording sheet at a secondary transfer nip described later. The residual toner remaining on the surface of the intermediate transfer belt 170 that has passed through the secondary transfer nip is cleaned by the belt cleaning device 90 that sandwiches the intermediate transfer belt 170 with the driving roller 15.

The secondary transfer device 22, disposed below the intermediate transfer device 17, brings a secondary transfer roller 23 into contact with a portion of the intermediate transfer belt 170 that is wound around the secondary transfer backup roller 16, thereby forming the secondary transfer nip. A secondary transfer bias having the same polarity as the toner is applied to the secondary transfer backup roller 16, whereas the secondary transfer roller 23 is grounded. Accordingly, a secondary transfer electric field is generated at the secondary transfer nip, electrostatically moving the multicolor toner image from the intermediate transfer belt 170 toward the secondary transfer roller 23. The action of the secondary transfer electric field and the nip pressure secondarily transfers the multicolor toner image onto the recording sheet, which is fed into the secondary transfer nip by the registration roller pair 49 in synchronization with the multicolor toner image on the intermediate transfer belt 170.

The feeding device 200, disposed at a lower portion in the housing of the printer 100, includes a paper bank 43 and an input tray 44 that accommodate a stack of recording sheets as a sheet bundle inside. A feeding roller 42 is pressed against an uppermost recording sheet of the sheet bundle accommodated in each of the paper bank 43 and the input tray 44. The feeding roller 42 is rotated to feed the uppermost recording sheet toward a feeding passage 46.

Multiple conveyance roller pairs 47 are disposed along the feeding passage 46 that receives the recording sheet fed from the paper bank 43 or the input tray 44. The registration roller pair 49 is disposed around an end of the feeding passage 46. The recording sheet is conveyed through the feeding passage 46 to the registration roller pair 49. The recording sheet conveyed to the registration roller pair 49 is sandwiched between the rollers of the registration roller pair 49. On the other hand, in the intermediate transfer device 17, the multicolor toner image formed on the intermediate transfer belt 170 enters the secondary transfer nip along with the looped movement of the intermediate transfer belt 170.

The activation of the registration roller pair 49 is timed to feed the recording sheet sandwiched between the rollers of the registration roller pair 49 to the secondary transfer nip to bring the recording sheet into close contact with the multicolor toner image at the secondary transfer nip. As a result, the multicolor toner image on the intermediate transfer belt 170 is brought into close contact with the recording sheet at the secondary transfer nip. Then, the toner image is secondarily transferred onto the recording sheet to be a full-color image on the white recording sheet. After the recording sheet bearing the full-color image exits the secondary transfer nip as the secondary transfer roller 23 is driven to rotate, the recording sheet is sent to the fixing device 25 via a sheet conveyance unit including a conveyance belt.

The fixing device 25 includes a belt unit and a pressure roller 27. The belt unit moves a fixing belt 26, which is stretched taut around two rollers, along a continuous loop. The pressure roller 27 is pressed against one of the rollers of the belt unit. The fixing belt 26 and the pressure roller 27 receive the recording sheet from the sheet conveyance unit and sandwich the recording sheet at a fixing nip formed between the fixing belt 26 and the pressure roller 27 in contact with each other. A fixing roller, which is one of the two rollers of the belt unit and is pressed by the pressure roller 27, includes a heat source (heater) inside to heat the fixing belt 26 by the heat generation of the heat source. The heated fixing belt 26 heats the recording sheet sandwiched at the fixing nip. The full-color image is fixed on the recording sheet by the influence of the heating and the nip pressure.

The recording sheet, having undergone the fixing process in the fixing device 25, is either placed on a stacker projecting from the left side plate of the copier housing or returned to the secondary transfer nip, where another toner image is formed on the opposite side of the recording sheet.

When a document is copied, for example, a bundle of document sheets is placed on a document tray 31 of the ADF 400. When the bundle of sheet documents is a side-bound document closed in book form, the document is placed on a platen 32. Before the side-bound document is placed on the platen 32, the ADF 400 is opened with respect to the copier body to expose the platen 32 of the scanner 300. After being placed on the platen 32, the side-bound document is pressed by the ADF 400 when the ADF 400 is closed.

Once the document is thus set, pressing a start key initiates a document reading operation by the scanner 300. On the other hand, when the bundle of document sheets is placed on the ADF 400, the ADF 400 automatically feeds the document sheets to the platen 32 prior to the document reading operation.

The document reading operation starts with the traveling of a first carrier 33 together with a second carrier 34. A light source carried on the first carrier 33 emits light. The light reflected from the surface of the document is further reflected by a mirror disposed in the second carrier 34 to an image forming lens 35. After passing through the image forming lens 35, the light enters a reading sensor 36 as incident light. The reading sensor 36 generates image information according to the incident light.

In parallel with the above-described document reading operation, the components of the developing stations 18S, 18G, 18R, 18B, and 18K, the intermediate transfer device 17, the secondary transfer device 22, and the fixing device 25 initiate the respective operations. According to the image information generated by the reading sensor 36, the optical writing device 21 is driven and controlled to form the S, G, R, B, and K toner images on the photoconductors 1S, 1G, 1R, 1B, and 1K, respectively. These toner images are superimposed and transferred onto the intermediate transfer belt 170 to form a multicolor toner image.

The feeding device 200 initiates a feeding operation almost simultaneously with the initiation of the document reading operation. In the feeding operation, the feeding device 200 selectively rotates one of the feeding rollers 42 to feed recording sheets from the paper bank 43 or the input tray 44. A separation roller 45 separates the recording sheets one by one and feeds the separated recording sheet to the feeding passage 46. The recording sheet entering the feeding passage 46 is conveyed toward the secondary transfer nip by conveyance roller pairs.

A controller including a central processing unit (CPU) is disposed in the housing of the printer 100 to control the devices. A control panel 500 including a liquid crystal display (LCD) and various keys is disposed on the upper surface of the housing. An operator transmits a command to the controller through an input operation on the control panel 500 to designate a simplex print mode in which an image is formed only on one side of a recording sheet or a duplex print mode in which images are formed on both sides of the recording sheet.

A bottle container 65 is disposed at an upper portion in the housing of the printer 100. The bottle container 65 accommodates toner bottles 51S, 51G, 51R, 51B, and 51K, which contain S toner, G toner, R toner, B toner, and K toner, respectively, for replenishment. Bottle drivers 52S, 52G, 52R, 52B, and 52K of toner supply devices for S, G, R, B, and K are fixed to the bottle container 65. These bottle drivers 52S, 52G, 52R, 52B, and 52K for S, G, R, B, and K detachably hold the toner bottles 51S, 51G, 51R, 51B, and 51K, respectively.

In FIG. 2, the developing stations 18S, 18G, 18R, 18B, and 18K for the respective colors are aligned to superimpose and primarily transfer the toner images onto the intermediate transfer belt 170 in the order of S, G, R, B, and K. However, depending on the type of the special color S, the color order of superimposition may be changed.

FIG. 3A is a schematic diagram illustrating a toner image formed by the copier. FIG. 3B is a schematic diagram illustrating the toner layers of the toner image of FIG. 3A. For example, when the special color S is transparent, a transparent toner layer is typically formed to impart gloss to the image. In this case, the order of colors to be superimposed may be S, G, R, B, and K, which may be referred to as a “default color order” in the following description, as illustrated in FIGS. 3A and 3B. Specifically, when the multicolor toner image formed on the intermediate transfer belt 170 by the superimposition in the default color order is secondarily transferred onto a recording sheet, the S toner is positioned uppermost (as a surface layer) among the S, G, R, B, and K toners as illustrated in FIG. 3A. When such a multicolor toner image passes through the fixing device 25 together with a recording sheet SH, a K toner layer, a B toner layer, an R toner layer, a G toner layer, and a transparent toner layer are sequentially laminated to form a multicolor toner image on the surface of the recording sheet SH as illustrated in FIG. 3B. The uppermost transparent toner layer serves to impart glossiness to the color image.

### Hardware Configuration of Computer

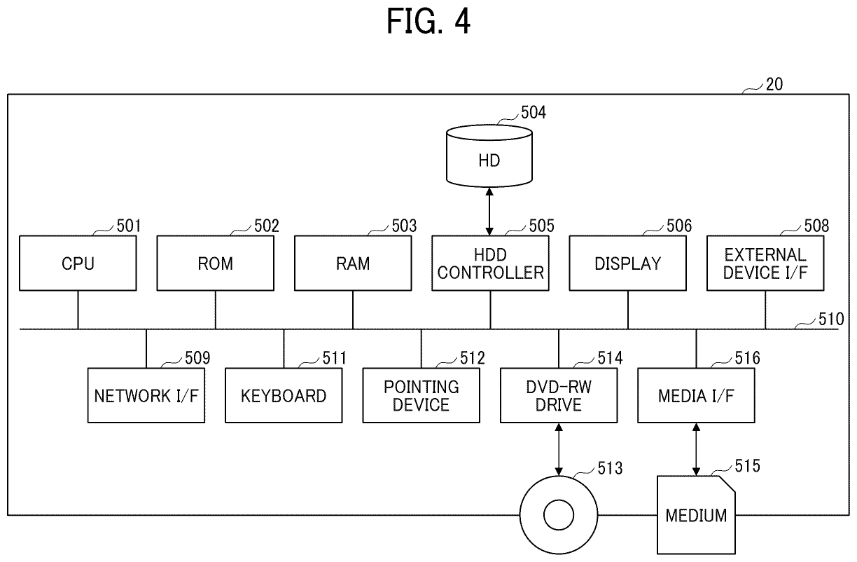

The information processing apparatus 20 may be implemented by a computer. FIG. 4 is a block diagram illustrating a hardware configuration of the information processing apparatus 20.

As illustrated in FIG. 4, the information processing apparatus 20 includes a CPU 501, a read-only memory (ROM) 502, a random-access memory (RAM) 503, a hard disk (HD) 504, a hard disk drive (HDD) controller 505, a display 506, an external device interface (I/F) 508, a network I/F 509, a bus line 510, a keyboard 511, a pointing device 512, a digital versatile disc rewritable (DVD-RW) drive 514, and a media I/F 516.

The CPU 501 controls the overall operation of the computer. The ROM 502 stores programs such as an initial program loader (IPL) to boot the CPU 501. The RAM 503 is used as a work area for the CPU 501. The HD 504 stores various data, such as programs. The HDD controller 505 controls the reading or writing of various data to or from the HD 504 under the control of the CPU 501. The ROM 502, the RAM 503, and the HD 504 are examples of memory or storage devices of the information processing apparatus 20.

The display 506 displays various information, such as the cursor, menus, windows, text, or image data. The external device I/F 508 is an interface that connects the information processing apparatus 20 to various external devices. In this case, the external devices include, for example, a universal serial bus (USB) memory stick and a printer. The network I/F 509 is an interface that enables data communication through the communication network N. The bus line 510 is, for example, an address bus or a data bus that electrically connects components such as the CPU 501.

The keyboard 511 is an example of an input device provided with multiple keys for entering characters, numerical values, and various instructions. The pointing device 512 is an example of an input device used for operations such as selecting and executing various instructions, selecting processing targets, and moving the cursor. The DVD-RW drive 514 controls the reading or writing of various data to or from a DVD-RW 513, which is an example of a removable recording medium. The removable storage medium is not limited to DVD-RW and may be, for example, a DVD-recordable (DVD-R). The media I/F 516 controls the reading or writing (storage) of data to or from a recording medium 515, such as flash memory.

### Hardware Configuration of Smartphone

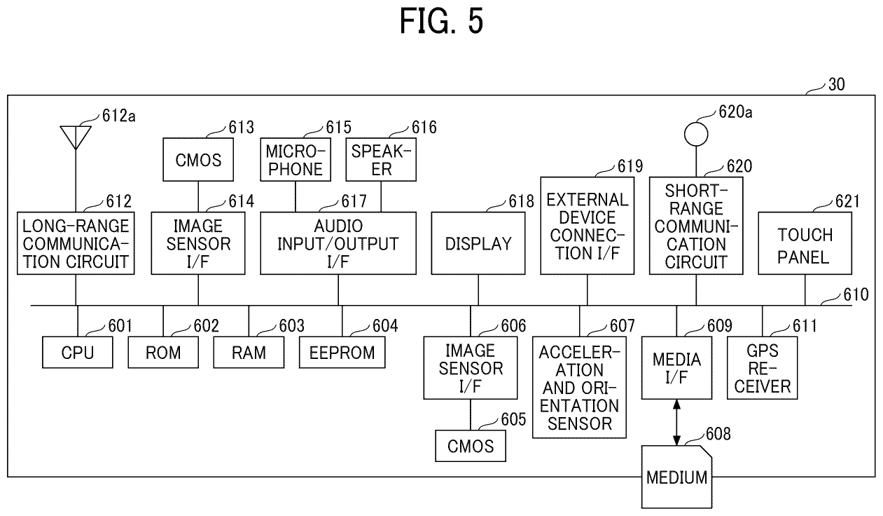

The terminal apparatus 30 may be implemented by a smartphone. FIG. 5 is a block diagram illustrating a hardware configuration of the terminal apparatus 30.

As illustrated in FIG. 5, the terminal apparatus 30 includes a CPU 601, a ROM 602, a RAM 603, an electrically erasable programmable read-only memory (EEPROM) 604, a complementary metal oxide semiconductor (CMOS) sensor 605, an image sensor I/F 606, an acceleration and orientation sensor 607, a media I/F 609, a bus line 610, and a Global Positioning System (GPS) receiver 611.

The CPU 601 is a processing unit that controls the overall operation of the terminal apparatus 30. The ROM 602 stores programs, such as an IPL, that are used to boot the CPU 601. The RAM 603 is used as a work area for the CPU 601. The EEPROM 604 reads or writes various data, such as a program for a smartphone, under the control of the CPU 601. The ROM 602, the RAM 603, and the EEPROM 604 are examples of memory or storage devices of the terminal apparatus 30.

The CMOS sensor 605 is an example of a built-in imaging device that captures a subject, such as a self-image of a user operating the terminal apparatus 30, and obtains image data under the control of the CPU 601. In alternative to the CMOS sensor 605, an imaging device such as a charge-coupled device (CCD) sensor may be used.

The image sensor I/F 606 is a circuit that controls the driving of the CMOS sensor 605. The acceleration and orientation sensor 607 includes various sensors, such as an electromagnetic compass for detecting geomagnetism, a gyrocompass, and an acceleration sensor. The media I/F 609 controls the reading or writing (storage) of data to or from a recording medium 608, such as flash memory. The bus line 610 is, for example, an address bus or a data bus that electrically connects components such as the CPU 601. The GPS receiver 611 receives GPS signals from a GPS satellite.

The terminal apparatus 30 further includes a long-range communication circuit 612, an antenna 612a of the long-range communication circuit 612, a CMOS sensor 613, an image sensor I/F 614, a microphone 615, a speaker 616, an audio input/output I/F 617, a display 618, an external device I/F 619, a short-range communication circuit 620, an antenna 620a of the short-range communication circuit 620, and a touch panel 621.

The long-range communication circuit 612 is a circuit that enables the terminal apparatus 30 to communicate with other devices via a communication network. The CMOS sensor 613 is an example of a built-in imaging device that captures a subject and obtains image data under the control of the CPU 601. The image sensor I/F 614 is a circuit that controls the driving of the CMOS sensor 613. The microphone 615 is a built-in circuit that converts sound into electrical signals. The speaker 616 is a built-in circuit that converts electrical signals into physical vibrations to produce sound, such as music and voice. The audio input/output I/F 617 is a circuit that processes the input and output of audio signals to and from the microphone 615 and the speaker 616 under the control of the CPU 601.

The display 618 is an example of a display device, such as an LCD or an organic electroluminescent display (OELD), for displaying subject images, various icons, and other visual information. The external device I/F 619 is an interface that connects the terminal apparatus 30 to various external devices. The short-range communication circuit 620 is a communication circuit in compliance with a communication protocol, such as the near field communication (NFC) or Bluetooth®. The touch panel 621 is an example of an input device that enables user operation of the terminal apparatus 30 by detecting presses on the display 618. The display 618 is an example of a display device included in the terminal apparatus 30.

The hardware configuration illustrated in FIG. 5 is an example of the terminal apparatus 30. The hardware configuration of the terminal apparatus 30 is not limited to that illustrated in FIG. 5. The hardware configuration of the terminal apparatus 30 may be, for example, the configuration illustrated in FIG. 4.

### Printed Material

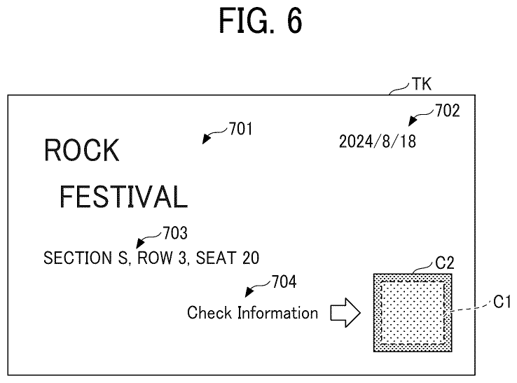

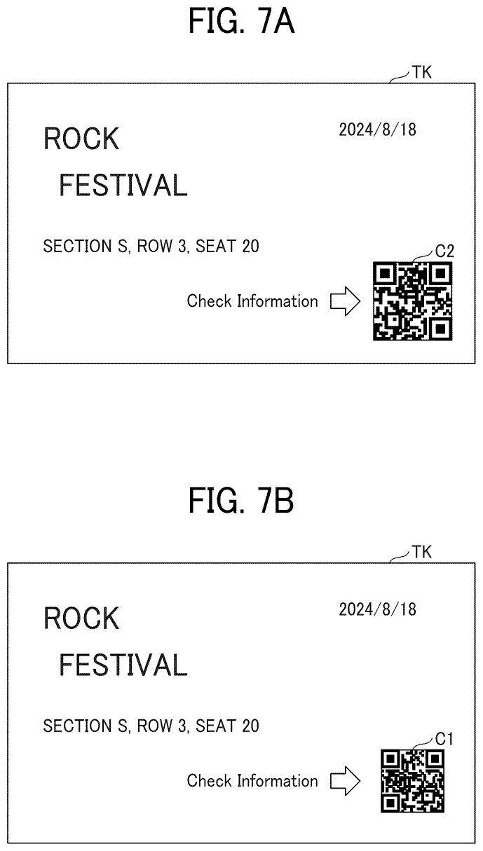

The printed material PM produced by the image forming apparatus 10 is described below with reference to FIGS. 6, 7A, and 7B. The printed material PM includes an invisible image, which is invisible or hardly visible under visible light (in a bright place) but is visible under black lights (in a dark place). The printed material PM is used such that the invisible image printed on the printed material PM is visible in a dark place. The invisible image may be any image that is less visible than the visible image under visible light.

The image forming apparatus 10 either superimposes invisible green, invisible red, and invisible blue, or selects one of these colors individually, to represent a desired invisible color. This color is visible under invisible light, yet hard to visually perceive under visible light. Invisible green refers to a green color visible under invisible light, yet hard to visually perceive under visible light. Invisible red refers to a red color visible under invisible light, yet hard to visually perceive under visible light. Invisible blue refers to a blue color visible under invisible light, yet hard to visually perceive under visible light. The invisible green, invisible red, and invisible blue are examples of invisible colors. Invisible colors are not limited to the aforementioned examples and may refer to any color visible under invisible light, yet hard to visually perceive under visible light.

Visible light refers to electromagnetic waves with wavelengths that are perceived as light by humans. Invisible light refers to electromagnetic waves with wavelengths outside the visible spectrum. In the present embodiment, invisible light includes ultraviolet rays emitted by black lights, such as long-wavelength ultraviolet radiation. In the present embodiment, invisible colors are transparent under visible light, such as light emitted by a fluorescent lamp or sunlight, whereas invisible colors become visible under invisible light, such as ultraviolet rays emitted by black lights.

Specifically, an invisible green image is formed with an invisible green toner. An invisible red image is formed with an invisible red toner. An invisible blue image is formed with an invisible blue toner. In the following description, the invisible green toner, the invisible red toner, and the invisible blue toner may be referred to as “G toner,” “R toner,” and “B toner,” respectively. An image of an invisible color other than invisible green, invisible red, and invisible blue is formed by superimposing at least two of the invisible color toners—G toner, R toner, and B toner.

Invisible black, which is a black color visible under invisible light, is formed by adhering none of the G toner, R toner, and B toner. A special color image visible under visible light is formed with a special color toner. A black image visible under visible light is formed with a black toner. In the following description, the special color toner and the black toner may be referred to as “S toner” and “K toner,” respectively.

Invisible color toner (also referred to as invisible toner) may be produced by combining a transparent toner (also referred to as clear toner) with a phosphor, such as a transparent phosphor. In other words, invisible color toner is typically produced with clear toner as a base. The transparent phosphor may be, for example, a transparent fluorescent pigment or a transparent fluorescent dye. Invisible color toner is a pulverized toner having a fixing temperature higher than that of a polymerized toner. Alternatively, invisible color toner may be a polymerized toner. Invisible colors may be represented by invisible color ink, such as ink produced by clear ink and transparent phosphor. Colorants including invisible color toner and invisible color ink are referred to as invisible colorants (colorants that express invisible colors). The invisible colorant includes a transparent phosphor and a medium, such as clear toner or clear ink. The invisible colorant is printed on a recording medium by an image forming apparatus, such as an electrophotographic printer with toner or an inkjet printer with ink. An invisible image is an image printed on a recording medium with an invisible colorant including a transparent phosphor. A printed material (or printed matter) may include both an invisible image formed with an invisible colorant and a visible image formed with a visible colorant, such as visible CMYK toners or CMYK inks.

FIG. 6 is a diagram illustrating an example of a printed material (or printed matter). The printed material PM may be a ticket TK for participating in an event. As illustrated in FIG. 6, images 701 to 704 indicating information related to the event may be formed on the ticket TK. Each of the images 701 to 704 may be a visible image that becomes visible under visible light or may be an invisible image that becomes visible under invisible light.

The image 701 is a text image indicating the name of the event. The image 702 is a text image indicating the date of the event. The image 703 is a text image indicating a seat assigned to the purchaser of the ticket TK. The image 704 is a text image indicating how to obtain additional information related to the event.

The ticket TK further includes a two-dimensional code C1 and a two-dimensional code C2. The two-dimensional code C1 is a two-dimensional code encoding first connection information, such as a Uniform Resource Locator (URL), and corresponds to a first code. The two-dimensional code C2 is a two-dimensional code encoding second connection information, such as a URL, and corresponds to a second code. Examples of the two-dimensional codes include Portable Data File 417 (PDF417) and Quick Response (QR) code. QR Code is a registered trademark of DENSO WAVE INCORPORATED. Although FIG. 6 illustrates an example in which the two-dimensional codes encoding the connection information are formed on the ticket TK, any type of code, such as a barcode or a color code, may be formed on the ticket TK.

The two-dimensional code C1 is an invisible image that becomes visible under invisible light. The two-dimensional code C2 is a visible image visible under visible light. In the following description, the two-dimensional code C1 and the two-dimensional code C2 may be referred to as an “invisible code” and a “visible code,” respectively. The first connection information encoded in the invisible code C1 may be referred to as “invisible connection information,” whereas the second connection information encoded in the visible code C2 may be referred to as “visible connection information.”

The invisible code C1 and the visible code C2 may at least partially overlap each other. The invisible code C1 and the visible code C2 may be formed in the same area in the same shape. The invisible code C1 may be smaller in area than the visible code C2. The invisible code C1 may be formed inside the area where the visible code C2 is formed. The invisible code C1 may be formed on the area where the visible code C2 is formed.

By forming the invisible code C1 and the visible code C2 in the same area, the space of the ticket TK can be effectively utilized. By forming the invisible code C1 inside the area where the visible code C2 is formed, the invisible code C1 can be made less perceptible. Since the invisible color toner is produced with clear toner as a base, the texture of the surface of the area where the invisible image is formed is different from that of the surrounding image forming medium. By forming the invisible image inside the visible image, the difference in texture between the area where the invisible image is formed and the surrounding area becomes difficult to perceive.

The visible code C2 may be formed in a visible color that is difficult to visually perceive under invisible light. For example, the visible code C2 may be formed in a light color with CMYK. The light color refers to, for example, a color in which all CMYK values are low. When the visible code C2 is formed in a light color, the invisible code C1 is clearly visible under invisible light, enhancing the reading accuracy of the invisible code C1.

FIG. 7A is a diagram illustrating a usage scene of a printed material under visible light. FIG. 7B is a diagram illustrating a usage scene of a printed material under invisible light. FIG. 7A illustrates the ticket TK of FIG. 6 placed under a fluorescent lamp (under visible light). FIG. 7B illustrates the ticket TK of FIG. 6 placed under black light (under invisible light).

As illustrated in FIGS. 7A and 7B, of the invisible code C1 and the visible code C2 formed on the ticket TK, only the visible code C2 is visible under visible light, whereas only the invisible code C1 is visible under invisible light. Therefore, when the two-dimensional code formed on the ticket TK is read under visible light, the visible connection information encoded in the visible code C2 is recognized. By contrast, when the two-dimensional code formed on the ticket TK is read under invisible light, the invisible connection information encoded in the invisible code C1 is recognized.

### Functional Configuration of Content Providing System

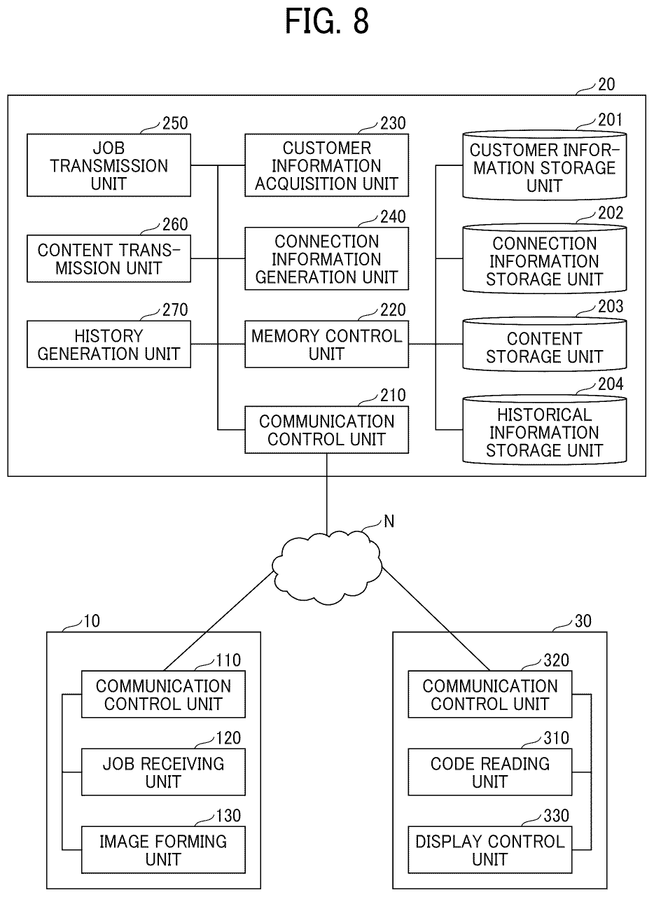

A functional configuration of the content providing system 1000 is described below with reference to FIG. 8.

FIG. 8 is a block diagram illustrating a functional configuration of the content providing system 1000.

### Image Forming Apparatus

As illustrated in FIG. 8, the image forming apparatus 10 includes a communication control unit 110, a job receiving unit 120, and an image forming unit 130.

The communication control unit 110 controls communication with the information processing apparatus 20. The communication control unit 110 may receive an image forming job from the information processing apparatus 20. The communication control unit 110 may transmit an image formation result to the information processing apparatus 20.

The image forming job may include image data, medium information, and setting information. The image data is electronic data representing an image to be formed on an image forming medium. The image data may be data in which text and images are laid out. The medium information indicates a type of image forming medium. The setting information includes information indicating parameters such as color mode (monochrome or color), image forming side (single-sided or double-sided), number of copies, and magnification, as well as information indicating whether the image represented by the image data is to be formed as a visible or invisible image on the image forming medium.

The job receiving unit 120 receives or accepts an image forming job. The job receiving unit 120 may receive the image forming job transmitted from the information processing apparatus 20. The job receiving unit 120 may receive an input of an image forming job in response to an operation on a control panel of the image forming apparatus 10.

The image forming unit 130 forms an image on an image forming medium based on the image forming job received by the job receiving unit 120. The image forming unit 130 may form the invisible code C1 on the image forming medium with an invisible colorant based on the setting information. The image forming unit 130 may form the visible code C2 on the image forming medium with a visible colorant based on the setting information.

The image forming unit 130 may form the invisible code C1 and the visible code C2 on the same image forming medium based on the setting information. The image forming unit 130 may form the visible code C2 on the image forming medium and form the invisible code C1 inside the area where the visible code C2 is formed.

### Information Processing Apparatus

As illustrated in FIG. 8, the information processing apparatus 20 includes a customer information storage unit 201, a connection information storage unit 202, a content storage unit 203, a historical information storage unit 204, a communication control unit 210, a memory control unit 220, a customer information acquisition unit 230, a connection information generation unit 240, a job transmission unit 250, a content transmission unit 260, and a history generation unit 270.

The customer information storage unit 201, the connection information storage unit 202, the content storage unit 203, and the historical information storage unit 204 are implemented by, for example, the HD 504 illustrated in FIG. 4. Data is read from or written to the HD 504 via, for example, the HDD controller 505.

The communication control unit 210, the memory control unit 220, the customer information acquisition unit 230, the connection information generation unit 240, the job transmission unit 250, the content transmission unit 260, and the history generation unit 270 are implemented by, for example, processing executed by the CPU 501 and the network I/F 509 according to a program loaded from the ROM 502 to the RAM 503 illustrated in FIG. 4.

The customer information storage unit 201 stores customer information. The customer information storage unit 201 may include a customer information table to store the customer information. In the present embodiment, the customer information is stored in advance in the customer information table.

The customer information is information related to a customer, such as the user U, to whom the printed material PM is distributed.

The customer information may include identification information for identifying the customer. The customer information may include information for generating an image formed on the printed material PM. The customer information is an example of user information.

The connection information storage unit 202 stores connection information. The connection information storage unit 202 may include a connection information table to store the connection information. The connection information stored in the connection information table may be generated by the connection information generation unit 240.

The connection information indicates a connection destination for receiving the content. The connection information may include, for example, a URL. The connection information may include invisible connection information encoded in an invisible code. The connection information may include visible connection information encoded in a visible code.

The connection information may be associated with customer information. The connection information may include identification information for identifying a customer.

The information processing apparatus 20 stores content in the content storage unit 203.

The content storage unit 203 may store content specified by the connection information. The content may include invisible content specified by the invisible connection information. The content may include visible content specified by the visible connection information. The invisible content is an example of first content, whereas the visible content is an example of second content. The invisible content and the visible content differ at least partially from each other. The content storage unit 203 may store a third content that differs at least partially from the invisible content and the visible content. Even when content is added to or deleted from the invisible content or the visible content, the content may be expressed as different content.

The historical information storage unit 204 stores historical information. The historical information storage unit 204 may include a historical information table to store the historical information. The historical information stored in the historical information table may be generated by the history generation unit 270.

The historical information indicates a history related to communication with the terminal apparatus 30. The historical information may include a history related to communication that originates from the terminal apparatus 30 and is based on the invisible connection information. The historical information may include information indicating whether the communication based on the invisible connection information is established. Whether the communication is established refers to whether communication based on connection information has occurred once or more after the connection information is generated.

The historical information may be associated with customer information. The historical information may include identification information for identifying a customer.

The communication control unit 210 controls communication with the image forming apparatus 10 and the terminal apparatus 30. The communication control unit 210 may transmit an image forming job to the image forming apparatus 10. The communication control unit 210 may receive an image formation result from the image forming apparatus 10. The communication control unit 210 may receive a connection request from the terminal apparatus 30. The communication control unit 210 may transmit content to the terminal apparatus 30.

The memory control unit 220 controls the storage of data in a storage device of the information processing apparatus 20.

The memory control unit 220 may read customer information from the customer information storage unit 201. The memory control unit 220 may write connection information to the connection information storage unit 202. The memory control unit 220 may read content from the content storage unit 203. The memory control unit 220 may read and write historical information to and from the historical information storage unit 204.

The customer information acquisition unit 230 acquires customer information. The customer information acquisition unit 230 may read customer information from the customer information storage unit 201. The customer information acquisition unit 230 may extract customer information from the customer information table. The customer information acquisition unit 230 may extract customer information with which connection information is not associated from the customer information table.

The connection information generation unit 240 generates connection information. The connection information generation unit 240 stores the generated connection information in the connection information storage unit 202. The connection information generation unit 240 may generate the connection information based on the customer information acquired by the customer information acquisition unit 230. The connection information generation unit 240 may store the connection information in the connection information storage unit 202 in association with the customer information.

The connection information generation unit 240 may generate invisible connection information for receiving invisible content. The connection information generation unit 240 may generate visible connection information for receiving visible content. The connection information generation unit 240 may generate the invisible connection information and the visible connection information based on customer information. The connection information generation unit 240 may include identification information for identifying a customer in the invisible connection information and the visible connection information.

The job transmission unit 250 transmits an image forming job to the image forming apparatus 10. The job transmission unit 250 may generate the image forming job based on the connection information read from the connection information storage unit 202. The job transmission unit 250 may generate an image forming job including an invisible code encoding the invisible connection information and a visible code encoding the visible connection information.

The job transmission unit 250 may store an image forming job in the storage device of the information processing apparatus 20. The job transmission unit 250 may monitor a job execution state of the image forming apparatus 10. When the image forming apparatus 10 is ready to execute a new image forming job, the job transmission unit 250 may read an image forming job from the storage device and transmit the read image forming job to the image forming apparatus 10.

The content transmission unit 260 transmits content to the terminal apparatus 30. The content transmission unit 260 may transmit the content to the terminal apparatus 30 through communication with the terminal apparatus 30. The content transmission unit 260 may transmit content read from the content storage unit 203 to the terminal apparatus 30.

The content transmission unit 260 may transmit content specified by the connection information to the terminal apparatus 30 according to the connection information used by the terminal apparatus 30 to connect to the information processing apparatus 20. The content transmission unit 260 may transmit invisible content to the terminal apparatus 30 in response to communication that originates from the terminal apparatus 30 and is based on the invisible connection information. The content transmission unit 260 may transmit visible content to the terminal apparatus 30 in response to communication that originates from the terminal apparatus 30 and is based on the visible connection information.

The content transmission unit 260 may control the content to be transmitted in response to the communication based on the visible connection information on the basis of historical information. When the historical information indicates that the communication based on the invisible connection information is established, that is, when communication has been established based on the invisible connection information in the past, the content transmission unit 260 may transmit the invisible content in response to the communication based on the visible connection information. By contrast, when the historical information indicates that no communication based on the invisible connection information is established, that is, when no communication has been established based on the invisible connection information in the past, the content transmission unit 260 may transmit the visible content in response to the communication based on the visible connection information.

The history generation unit 270 generates historical information. The history generation unit 270 stores the generated historical information in the historical information storage unit 204. The history generation unit 270 may generate historical information related to communication with the terminal apparatus 30. The history generation unit 270 may generate historical information indicating whether the communication, which originates from the terminal apparatus 30 and is based on the invisible connection information, is established.

### Terminal Apparatus

As illustrated in FIG. 8, the terminal apparatus 30 includes a code reading unit 310, a communication control unit 320, and a display control unit 330.

The code reading unit 310, the communication control unit 320, and the display control unit 330 are implemented by, for example, processing executed by the CPU 601, the long-range communication circuit 612, or the display 618 according to a program loaded from the ROM 602 to the RAM 603 illustrated in FIG. 5.

The code reading unit 310 reads a code formed on the printed material PM. The code reading unit 310 may read a code included in image data obtained by capturing an image of the printed material PM as a subject using the CMOS sensor 613 (or the CMOS sensor 605).

The code reading unit 310 may read the invisible code C1 under invisible light. The code reading unit 310 may read a two-dimensional code included in image data obtained by capturing an image of the printed material PM irradiated with invisible light, such as ultraviolet rays emitted by a black light.

The code reading unit 310 may read the visible code C2 under visible light. The code reading unit 310 may read a two-dimensional code included in image data obtained by capturing an image of the printed material PM irradiated with visible light, such as light emitted by a fluorescent lamp or sunlight.

The code reading unit 310 recognizes connection information encoded in the read code. The code reading unit 310 may decode the connection information encoded in the read code. When the code reading unit 310 reads the invisible code C1, the code reading unit 310 recognizes invisible connection information encoded in the invisible code C1. When the code reading unit 310 reads the visible code C2, the code reading unit 310 recognizes visible connection information encoded in the visible code C2.

The communication control unit 320 controls communication with the information processing apparatus 20. The communication control unit 320 may transmit a connection request to the information processing apparatus 20. The communication control unit 320 may transmit a connection request based on the connection information recognized by the code reading unit 310. When the code reading unit 310 recognizes the invisible connection information, the communication control unit 320 transmits a connection request to the information processing apparatus 20 for communication based on the invisible connection information. By contrast, when the code reading unit 310 recognizes the visible connection information, the communication control unit 320 transmits a connection request to the information processing apparatus 20 for communication based on the visible connection information.

The communication control unit 320 may receive content from the information processing apparatus 20. The communication control unit 320 may receive the content transmitted by the information processing apparatus 20 in response to the connection request.

The communication control unit 320 may receive invisible content transmitted by the information processing apparatus 20.

The communication control unit 320 may receive visible content transmitted by the information processing apparatus 20.

The display control unit 330 performs control to display information to be presented to the user U on the display 618. The display control unit 330 may display the content received from the information processing apparatus 20 on the display 618. In response to the invisible content from the information processing apparatus 20, the display control unit 330 displays the invisible content on the display 618. By contrast, in response to the visible content from the information processing apparatus 20, the display control unit 330 displays the visible content on the display 618.

### Customer Information Table

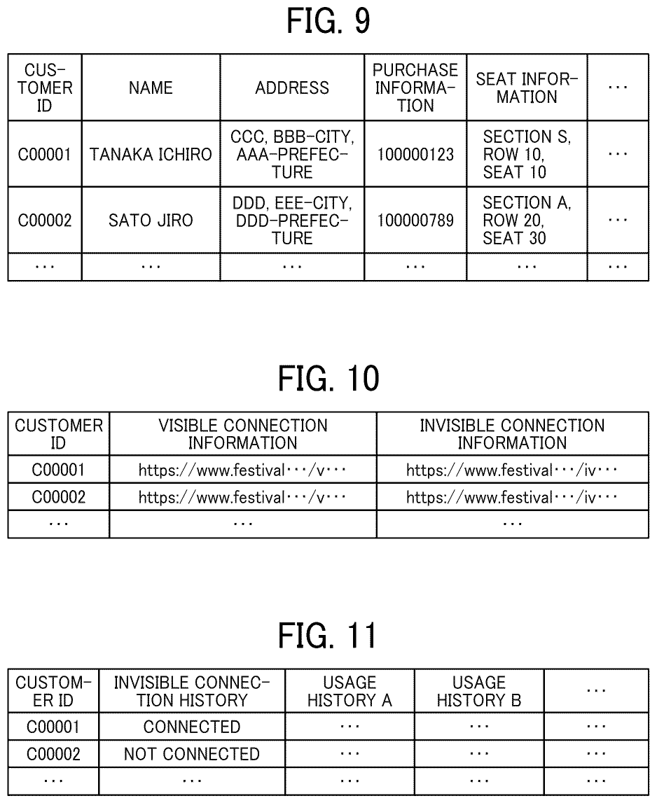

FIG. 9 is a diagram illustrating a customer information table. As illustrated in FIG. 9, the customer information table may include, as data items, a customer identification (ID), a name, an address, purchase information, and seat information.

The customer ID is an example of identification information for identifying a customer, such as the user U. The name, the address, the purchase information, or the seat information is an example of information for forming an image on the printed material PM. For example, the seat information may be used to generate the image 703 formed on the ticket TK illustrated in FIG. 6.

### Connection Information Table

FIG. 10 is a diagram illustrating a connection information table. As illustrated in FIG. 10, the connection information table may include, as data items, a customer ID, visible connection information, and invisible connection information. The customer ID is substantially similar to the customer ID included in the customer information table.

The visible connection information indicates a connection destination for receiving visible content. The visible connection information may include the customer ID or information that can identify the customer ID. The invisible connection information indicates a connection destination for receiving invisible content. The invisible connection information may include the customer ID or information that can identify the customer ID.

Although an example has been described with reference to FIG. 10 in which the connection information is generated in advance for each customer and stored in the connection information table, the connection information may be configured by adding a customer ID to basic connection information, such as a root directory, thus being generated each time. In this case, it is not necessary to generate the connection information in advance, rendering the connection information table unnecessary.

### Historical Information Table

FIG. 11 is a diagram illustrating a historical information table. As illustrated in FIG. 11, the historical information table may include, as data items, a customer ID, an invisible connection history, and a usage history. The customer ID is substantially similar to the customer ID included in the customer information table.

The invisible connection history is an example of information indicating whether communication based on the invisible connection information is established. The invisible connection history stores a first value indicating that a connection is established, or a second value indicating a connection is not established. The first value is represented by, for example, “true,” “1,” or “connected,” whereas the second value is represented by, for example, “false,” “0,” or “not connected.” In FIG. 11, “connected” indicates that a connection is established, whereas “not connected” indicates that a connection is not established.

The usage history is historical information related to the usage of the ticket TK, which is an example of the printed material PM. As an example, the usage history may include a payment history for a ticket purchase, a history of an entry into the event venue, and a history of receiving a novelty. Multiple usage histories may be included in the historical information. Each usage history may be a history related to any usage.

### Procedure of Image Forming Method

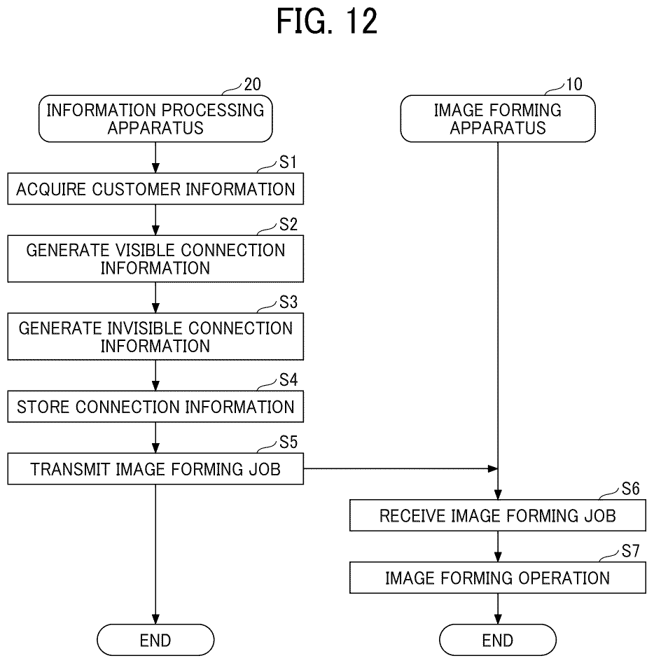

A procedure of an image forming method executed by the content providing system 1000 is described below with reference to FIG. 12. FIG. 12 is a flowchart of an image forming method.

In step S1, the customer information acquisition unit 230 of the information processing apparatus 20 requests the memory control unit 220 to transmit customer information. The memory control unit 220 reads customer information that is not associated with connection information stored in the connection information table among pieces of customer information stored in the customer information table. The memory control unit 220 transmits the read customer information to the customer information acquisition unit 230. The customer information acquisition unit 230 transmits the customer information received from the memory control unit 220 to the connection information generation unit 240.

In step S2, the connection information generation unit 240 of the information processing apparatus 20 receives the customer information from the customer information acquisition unit 230. The connection information generation unit 240 generates visible connection information based on the customer information. Specifically, the connection information generation unit 240 generates the visible connection information by including a customer ID in a URL indicating a connection destination for receiving visible content.

In step S3, the connection information generation unit 240 of the information processing apparatus 20 generates invisible connection information based on the customer information. Specifically, the connection information generation unit 240 generates the invisible connection information by including a customer ID in a URL indicating a connection destination for receiving invisible content.

In step S4, the connection information generation unit 240 of the information processing apparatus 20 requests the memory control unit 220 to store the visible connection information generated in step S2 and the invisible connection information generated in step S3. The memory control unit 220 stores the customer ID, the invisible connection information, and the visible connection information in the connection information table in association with one another.

In step S5, the job transmission unit 250 of the information processing apparatus 20 requests the memory control unit 220 to transmit connection information. The memory control unit 220 reads the connection information from the connection information table. The memory control unit 220 may read connection information that satisfies a predetermined condition.

For example, the memory control unit 220 may read only the connection information related to a customer ID for which the ticket TK has not been issued. The memory control unit 220 transmits the read connection information to the job transmission unit 250.

The job transmission unit 250 generates an image forming job for forming an image of the ticket TK based on the connection information received from the memory control unit 220. Specifically, the job transmission unit 250 encodes the visible connection information and the invisible connection information to generate a visible code and an invisible code, respectively. Then, the job transmission unit 250 generates an image forming job including an image of the ticket TK in which the visible code and the invisible code are laid out. The job transmission unit 250 may set setting information indicating that the visible code is to be formed on an image forming medium as a visible image, and set setting information indicating that the invisible code is to be formed on an image forming medium as an invisible image. The job transmission unit 250 requests the communication control unit 210 to transmit the generated image forming job. The communication control unit 210 transmits the image forming job to the image forming apparatus 10.

In step S6, the communication control unit 110 of the image forming apparatus 10 receives the image forming job from the information processing apparatus 20. The communication control unit 110 transmits the received image forming job to the job receiving unit 120. The job receiving unit 120 receives the image forming job transmitted from the communication control unit 110. The job receiving unit 120 stores the received image forming job in the storage device.

In step S7, the image forming unit 130 of the image forming apparatus 10 reads the unprocessed image forming job from the storage device. The image forming unit 130 forms an image of the ticket TK on an image forming medium based on the read image forming job. Specifically, the image forming unit 130 forms the visible code C2 with a visible colorant on the image forming medium. Subsequently, the image forming unit 130 forms the invisible code C1 with an invisible colorant inside the area where the visible code C2 is formed. When forming the visible code C2, the image forming unit 130 may perform control to reduce the CMYK values to thresholds or less to form the visible code C2 in a light color.

The ticket TK produced by the image forming apparatus 10 is distributed to the user U. The ticket TK may be distributed to the user U by any means, such as mailing, home delivery, or receipt at a store.

### Procedure of Content Providing Method

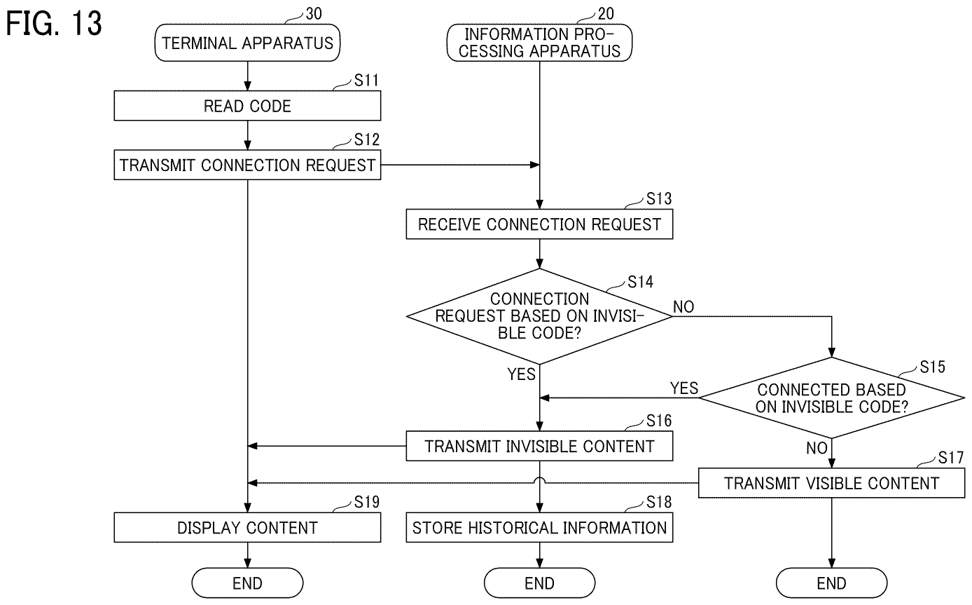

A procedure of a content providing method executed by the content providing system 1000 is described below with reference to FIG. 13. FIG. 13 is a flowchart of a content providing method.

In step S11, the code reading unit 310 of the terminal apparatus 30 reads the code formed on the ticket TK. The code reading unit 310 recognizes the connection information encoded in the read code. The code reading unit 310 transmits the recognized connection information to the communication control unit 320.

The code reading unit 310 may read the code formed on the ticket TK under invisible light. In this case, the code reading unit 310 reads the invisible code formed on the ticket TK and recognizes the invisible connection information encoded in the invisible code.

The code reading unit 310 may read the code formed on the ticket TK under visible light. In this case, the code reading unit 310 reads the visible code formed on the ticket TK and recognizes the visible connection information encoded in the visible code.

In step S12, the code reading unit 310 of the terminal apparatus 30 requests the communication control unit 320 to perform communication based on the connection information recognized in step S11. The communication control unit 320 transmits a connection request to the information processing apparatus 20 for communication based on the connection information received from the code reading unit 310 in step S11. When the invisible code is read in step S11, the communication control unit 320 transmits a connection request to the information processing apparatus 20 for communication based on the invisible connection information. By contrast, when the visible code is read in step S11, the communication control unit 320 transmits a connection request to the information processing apparatus 20 for communication based on the visible connection information.

In step S13, the communication control unit 210 of the information processing apparatus 20 receives the connection request from the terminal apparatus 30. The communication control unit 210 accepts the received connection request. The communication control unit 210 transmits the connection information indicated by the accepted connection request to the content transmission unit 260.

In step S14, the content transmission unit 260 of the information processing apparatus 20 receives the connection information from the communication control unit 210.

The content transmission unit 260 determines whether the connection request accepted in step S13 is a connection request based on the invisible code. In other words, the content transmission unit 260 determines whether the connection information indicated by the connection request is visible connection information or invisible connection information.

Specifically, the content transmission unit 260 acquires a customer ID from the connection information and reads the invisible connection information and the visible connection information, each associated with the customer ID, from the connection information table.

The content transmission unit 260 compares the connection information indicated by the connection request with each of the invisible connection information and the visible connection information read from the connection information table. When the connection information indicated by the connection request matches the invisible connection information, the content transmission unit 260 determines that the connection request is a connection request based on the invisible code. By contrast, when the connection information indicated by the connection request matches the visible connection information, the content transmission unit 260 determines that the connection request is not a connection request based on the invisible code.

When the content transmission unit 260 determines that the connection request is a connection request based on the invisible code (YES in step S14), the process proceeds to step S16. By contrast, the content transmission unit 260 determines that the connection request is not a connection request based on the invisible code (NO in step S14), the process proceeds to step S15.

In step S15, the content transmission unit 260 of the information processing apparatus 20 determines whether the customer, such as the user U, has established communication based on the invisible code. Specifically, the content transmission unit 260 acquires a customer ID from the connection information and reads the historical information associated with the customer ID from the historical information table. The content transmission unit 260 determines whether the value of the invisible connection history of the historical information is the first value indicating that a connection is established or the second value indicating that a connection is not established.

When the content transmission unit 260 determines that the communication based on the invisible code is established (YES in step S15), the process proceeds to step S16. By contrast, when the content transmission unit 260 determines that the communication based on the invisible code is not established (NO in step S15), the process proceeds to step S17.

In step S16, the content transmission unit 260 of the information processing apparatus 20 requests the memory control unit 220 to read invisible content. The memory control unit 220 reads invisible content from the content storage unit 203. The memory control unit 220 transmits the read invisible content to the communication control unit 210.

The content transmission unit 260 requests the communication control unit 210 to transmit the invisible content.

The communication control unit 210 transmits the invisible content to the terminal apparatus 30 through the communication with the terminal apparatus 30 established in step S13.

In step S17, the content transmission unit 260 of the information processing apparatus 20 requests the memory control unit 220 to read visible content. The memory control unit 220 reads visible content from the content storage unit 203. The memory control unit 220 transmits the read visible content to the communication control unit 210.

The content transmission unit 260 requests the communication control unit 210 to transmit the visible content. The communication control unit 210 transmits the visible content to the terminal apparatus 30 through the communication with the terminal apparatus 30 established in step S13.

In step S18, the history generation unit 270 of the information processing apparatus 20 generates historical information indicating that the communication based on the invisible connection information is established. At this time, the history generation unit 270 can generate the historical information in association with the customer ID acquired based on the connection information. The history generation unit 270 requests the memory control unit 220 to write the generated historical information.

The memory control unit 220 sets the value of the invisible connection history of the historical information to the first value indicating that a connection is established so as to be associated with the acquired customer ID, and stores the value in the historical information table. When the historical information associated with the customer ID has been stored in the historical information table, the memory control unit 220 updates the value of the invisible connection history of the historical information to the first value indicating that a connection is established.

In step S19, the communication control unit 320 of the terminal apparatus 30 receives the content from the information processing apparatus 20. The communication control unit 320 transmits the received content to the display control unit 330. The display control unit 330 displays the content received from the communication control unit 320 on the display 506.

Specifically, when the information processing apparatus 20 transmits the invisible content in step S16, the display control unit 330 displays the invisible content. The invisible content is transmitted in step S16 when the terminal apparatus 30 reads the invisible code in step S11 or when the terminal apparatus 30 reads the visible code in step S11 and the communication, which originates from the terminal apparatus 30 and is based on the invisible connection information, is established.

By contrast, when the information processing apparatus 20 transmits the visible content in step S17, the display control unit 330 displays the visible content. The visible content is transmitted in step S17 when the terminal apparatus 30 reads the visible code in step S11 and the communication, which originates from the terminal apparatus 30 and is based on the invisible connection information, is not established.

When the code formed on the ticket TK is read under invisible light, the information processing apparatus 20 always transmits invisible content to the terminal apparatus 30. By contrast, when the code formed on the ticket TK is read under visible light, the information processing apparatus 20 provides visible content provided that the code formed on the ticket TK has never been read under invisible light in the past, and transmits invisible content to the terminal apparatus 30 provided that the code formed on the ticket TK has ever been read under invisible light in the past. In other words, the information processing apparatus 20 can control the content to be transmitted to the terminal apparatus 30 when the code formed on the ticket TK is read under visible light, depending on whether the code formed on the ticket TK has been read under invisible light in the past.

### Examples of Application

The content providing system 1000 according to the present embodiment may be applied, by way of example, to the following uses.

Content to be provided prior to admission and content to be provided after admission are prepared for event attendees. The content to be provided prior to admission is stored as visible content. By contrast, the content to be provided after admission is stored as invisible content.

When the user U who is an event attendee reads the visible code C2 of the ticket TK with the terminal apparatus 30 in a period after receiving the ticket TK and before the event starts, the visible content specified by the visible connection information, that is, the content to be provided prior to admission, is displayed on the terminal apparatus 30. The content displayed at this time may include information such as a map of the area surrounding the event venue and an event timetable.

When the user U visits a specific place such as an event venue, a staff member such as a receptionist at the venue illuminates the ticket TK with black light to enable the invisible code C1 formed on the ticket TK to be read. When the user U reads the invisible code C1 with the terminal apparatus 30, the invisible content specified by the invisible connection information, that is, the content to be provided after admission, is displayed on the terminal apparatus 30.

Once the terminal apparatus 30 reads the invisible code C1 and is connected to the information processing apparatus 20, the invisible connection history indicates “connected.” When the user U who has been admitted as an event attendee reads the code of the ticket TK again in the venue, the visible code is read because the ticket TK is not under the irradiation of the black light. Even in this case, since the invisible connection history indicates “connected,” the invisible content, that is, the content to be provided after admission, is displayed on the terminal apparatus 30.

Another example of application involves providing content for pre-event interaction among event participants before the event starts. In addition, content for displaying a result of the pre-event interaction may be provided after the event has started. For example, when visiting the venue, the event participants can view a ranking that reflects the level of engagement in the pre-event interaction among the event participants. Even when the event participants meet face-to-face for the first time at the venue, they can quickly build rapport due to the shared topic of pre-event interaction, thereby enhancing the atmosphere of the event.

### First Modification

In the above description, when the code formed on the ticket TK is read under visible light and the code formed on the ticket TK has been read under invisible light even once in the past, the information processing apparatus 20 transmits invisible content to the terminal apparatus 30. In this case, when the terminal apparatus 30 reads the visible code to display the visible content, only the invisible content is displayed on the terminal apparatus 30, which may be inconvenient for some users. To address such a situation, when the code formed on the ticket TK is read under visible light and the code formed on the ticket TK has been read under invisible light even once in the past, the information processing apparatus 20 may transmit the third content to the terminal apparatus 30.

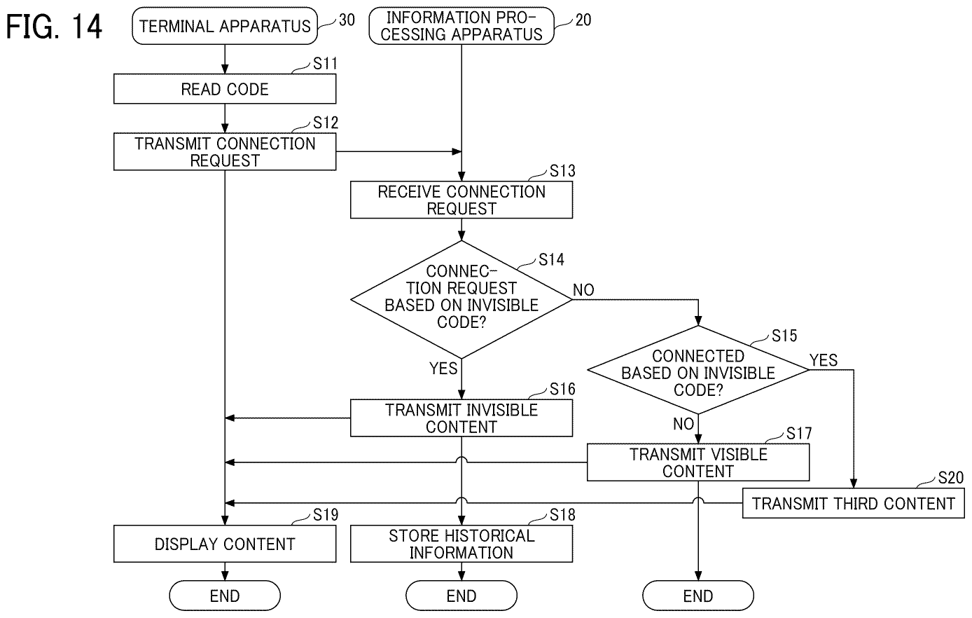

A modified content providing method executed by the content providing system 1000 is described below with reference to FIG. 14. FIG. 14 is a flowchart of a content providing method according to a first modification. In the following, descriptions will be omitted for processes that are identical or similar to those already described.

When the content transmission unit 260 determines that the communication based on the invisible code is established (YES in step S15), the process proceeds to step S20. By contrast, when the content transmission unit 260 determines that the communication based on the invisible code is not established (NO in step S15), the process proceeds to step S17.

In step S20, the content transmission unit 260 of the information processing apparatus 20 requests the memory control unit 220 to read the third content. The memory control unit 220 reads the third content from the content storage unit 203. The memory control unit 220 transmits the read third content to the communication control unit 210.

When the information processing apparatus 20 transmits the third content in step S20, the display control unit 330 displays the third content in step S19. The third content is transmitted in step S20 when the terminal apparatus 30 reads the visible code in step S11 and the communication, which originates from the terminal apparatus 30 and is based on the invisible connection information, is established.

The third content may include both visible content and invisible content. However, the third content is not limited to this, and may include content different from both the visible content and the invisible content.

According to the present modification, the content providing system 1000 can provide a broader range of content, facilitating better responsiveness to user needs.

### Second Modification

In the above description, the information processing apparatus 20 always transmits the invisible content (or the third content) when the invisible code formed on the ticket TK is read under the invisible light condition. Under the invisible light condition, a staff member such as a receptionist irradiates the ticket TK of a user visiting a specific place such as an event venue, with black light to enable the invisible code superimposed on the visible code to be read. However, the user may notice the presence of the invisible code before the user visits the event venue, and may directly read the visible code by irradiating the invisible code with black light. In this case, before the user visits the event venue, the user may receive invisible content that can be viewed only by the event attendees. To prevent such a situation, the information processing apparatus 20 may transmit the visible content when the invisible code of the ticket TK is read before a predetermined date.

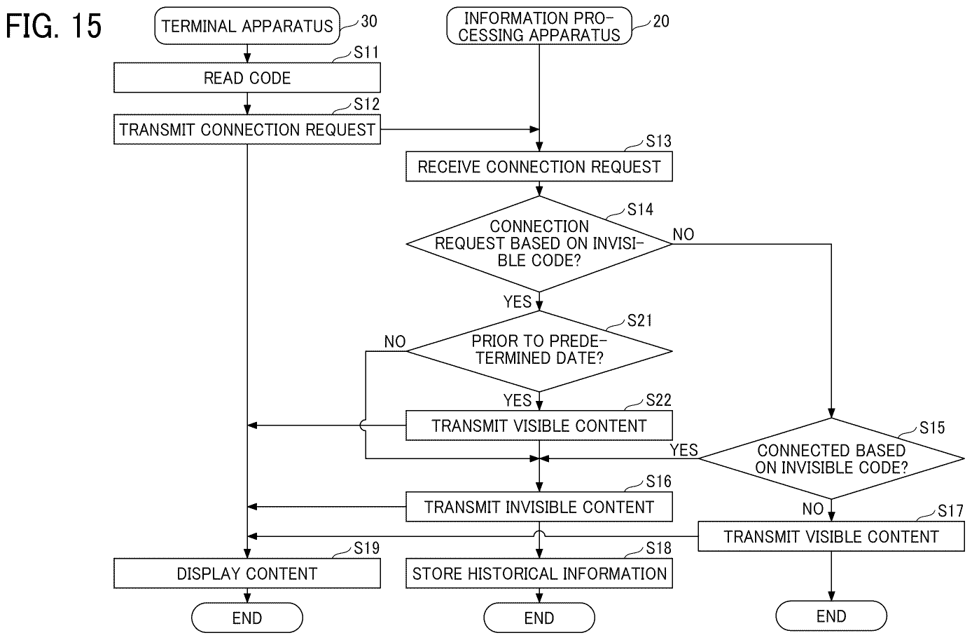

A modified content providing method executed by the content providing system 1000 is described below with reference to FIG. 15. FIG. 15 is a flowchart of a content providing method according to a second modification. In the following, descriptions will be omitted for processes that are identical or similar to those already described.

When the content transmission unit 260 determines that the connection request is a connection request based on the invisible code (YES in step S14), the process proceeds to step S21.

In step S21, the content transmission unit 260 of the information processing apparatus 20 determines whether the connection request based on the invisible code is received prior to a predetermined date, such as a date when an event is held. When the content transmission unit 260 determines that the connection request based on the invisible code is received prior to the predetermined date (YES in step S21), the process proceeds to step S22. By contrast, when the content transmission unit 260 determines that the connection request based on the invisible code is received on or after the predetermined date (NO in step S21), the process proceeds to step S16.

In step S22, the content transmission unit 260 of the information processing apparatus 20 requests the memory control unit 220 to read visible content. The memory control unit 220 transmits the read visible content to the communication control unit 210. The communication control unit 210 transmits the visible content to the terminal apparatus 30. When the information processing apparatus 20 transmits the visible content in step S22, the display control unit 330 displays the visible content in step S19.

According to the present modification, the content providing system 1000 can prevent the invisible content from being provided to a user who has not visited the event venue, thereby protecting the information to be provided after admission.

### Third Modification

In the above description, the information processing apparatus 20 transmits the invisible content or the third content when the invisible code formed on the ticket TK is read under the invisible light condition on or after the predetermined date. In other words, anyone can read the invisible code and receive the invisible content under the invisible light condition, provided that the user holds the ticket TK on or after the predetermined date. If the user who has purchased the ticket TK loses the ticket TK after the predetermined date, there is a risk that a third party who has not purchased the ticket TK may receive the invisible content. To prevent such a situation, in response to the connection request based on the invisible code, the information processing apparatus 20 may transmit a request for input of authentication information to the terminal apparatus 30.

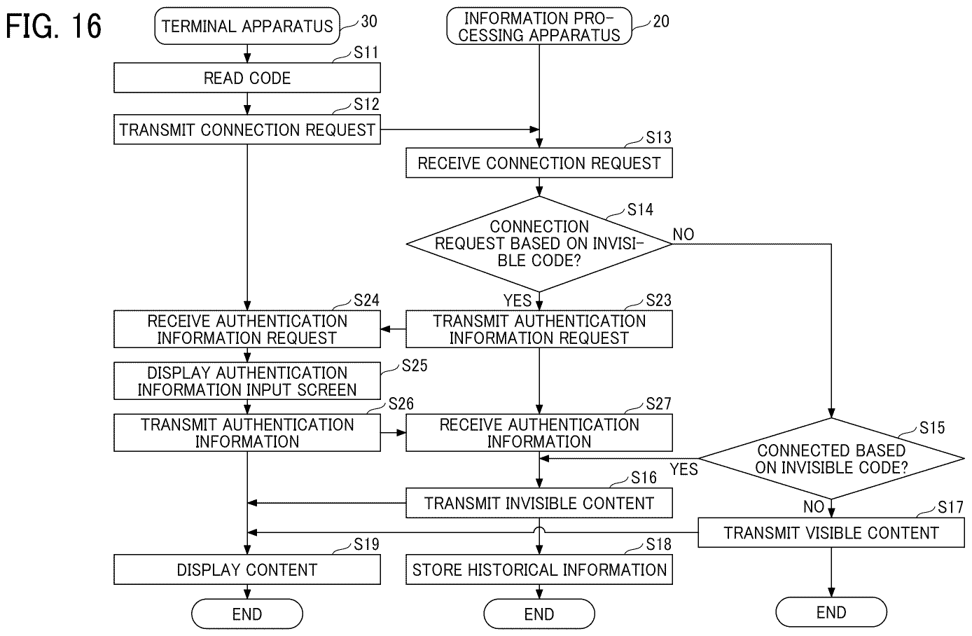

A modified content providing method executed by the content providing system 1000 is described below with reference to FIG. 16. FIG. 16 is a flowchart of a content providing method according to a third modification. In the following, descriptions will be omitted for processes that are identical or similar to those already described.

When the content transmission unit 260 determines that the connection request is a connection request based on the invisible code (YES in step S14), the process proceeds to step S23.

In step S23, the content transmission unit 260 of the information processing apparatus 20 transmits a request for input of authentication information to the terminal apparatus 30. In step S24, the communication control unit 320 of the terminal apparatus 30 receives the request for input of authentication information from the information processing apparatus 20. In step S25, the display control unit 330 of the terminal apparatus 30 displays an authentication information entry screen. In step S26, the communication control unit 320 of the terminal apparatus 30 transmits authentication information that is input by the user via the touch panel 621 to the information processing apparatus 20.

In step S27, the communication control unit 210 of the information processing apparatus 20 receives the authentication information transmitted from the terminal apparatus 30, and compares the received authentication information with authentication information registered in advance in the information processing apparatus 20, thereby performing an authentication process. When the authentication is successful as a result of the authentication process, that is, when the received authentication information matches the authentication information registered in advance in the information processing apparatus 20, the process proceeds to step S16. The subsequent steps are substantially similar to those in the first embodiment. By contrast, when the authentication fails as a result of the authentication process, the information processing apparatus 20 may notify the terminal apparatus 30 that the authentication fails and end the process.

According to the present modification, under the invisible light condition on or after a predetermined date, such as the event day, the content providing system 1000 can prevent the leakage of the invisible content, which is intended solely for event attendees, to users who have not purchased the tickets TK.

As described above, the information processing apparatus 20 stores, in a storage device, historical information related to communication that originates from the terminal apparatus 30 and is based on invisible connection information. Based on the historical information, the information processing apparatus 20 transmits either invisible content, which is specified by the invisible connection information, or visible content, which is specified by visible connection information, to the terminal apparatus 30 in response to communication that originates from the terminal apparatus 30 and is based on the visible connection information.

In one aspect, according to the present embodiment, the content to be transmitted to a terminal apparatus can be controlled without using information specific to the terminal apparatus. In another aspect, according to the present embodiment, appropriate content can be provided to the terminal apparatus without the information specific to the terminal apparatus.

When the historical information indicates that the communication based on the invisible connection information is not established, the information processing apparatus 20 may transmit the visible content in response to the communication based on the visible connection information. When the historical information indicates that the communication based on the invisible connection information is established, the information processing apparatus 20 may transmit the invisible content in response to the communication based on the visible connection information. In one aspect, according to the present embodiment, appropriate content can be transmitted in response to the communication based on the visible connection information, depending on whether the communication based on invisible connection information is established.

The invisible connection information and the visible connection information may be associated with customer information related to the user U who operates the terminal apparatus 30. The information processing apparatus 20 may store historical information for each piece of customer information. In one aspect, according to the present embodiment, appropriate content can be transmitted for each customer without using the information specific to the terminal apparatus.

The communication based on the invisible connection information may be initiated through the reading of an invisible code that includes the invisible connection information. The communication based on the visible connection information may be initiated through the reading of a visible code that includes the visible connection information. In one aspect, according to the present embodiment, appropriate content can be transmitted through a simple operation by a user.

The invisible code may be an invisible image visible under invisible light. The visible code may be a visible image visible under visible light. The invisible code and the visible code may be formed on the same image forming medium. In one aspect, according to the present embodiment, once the code is read under invisible light, appropriate content can be transmitted even when the code is read under visible light.

The invisible code may be formed inside an area where the visible code is formed. In one aspect, according to the present embodiment, the space of the image forming medium can be effectively utilized.

The visible code may be formed in a color that is difficult to visually perceive under invisible light. In other words, the visible code may be formed in a color having reduced visibility under invisible light compared to visible light. In one aspect, according to the present embodiment, the invisible code can be accurately read under the invisible light.

A description is given below of several aspects of the present disclosure.

According to a first aspect, an information processing apparatus that is capable of communicating with a terminal apparatus via a network includes a memory control unit and a content transmission unit. The memory control unit stores, in a memory or storage device, historical information related to first communication originating from the terminal apparatus and based on first connection information. The content transmission unit transmits, based on the historical information, either a first content specified by the first connection information or a second content specified by second connection information to the terminal apparatus in response to second communication originating from the terminal apparatus and based on the second connection information.

According to a second aspect, in the information processing apparatus of the first aspect, when the historical information indicates that the first communication is not established, the content transmission unit transmits the second content in response to the second communication. When the historical information indicates that the first communication is established, the content transmission unit transmits the first content in response to the second communication.

According to a third aspect, in the information processing apparatus of the first or second aspect, the first connection information and the second connection information are associated with user information related to a user who operates the terminal apparatus. The memory control unit stores the historical information for each user identified by the user information.

According to a fourth aspect, in the information processing apparatus of any one of the first to third aspects, the content transmission unit transmits the second content in response to the first communication originating from the terminal apparatus and based on the first connection information, the first communication being received before a predetermined date and time.

According to a fifth aspect, in the information processing apparatus of any one of the first to fourth aspects, the content transmission unit requests the input of authentication information in response to the first communication originating from the terminal apparatus and based on the first connection information, and transmits the first content specified by the first connection information based on a result of the input.

According to a sixth aspect, in the information processing apparatus of any one of the first to fifth aspects, the first communication is initiated through the reading of a first code including the first connection information, whereas the second communication is initiated through the reading of a second code including the second connection information.

According to a seventh aspect, in the information processing apparatus of the sixth aspect, the first code is an invisible image visible under invisible light, whereas the second code is a visible image visible under visible light.

According to an eighth aspect, in the information processing apparatus of the sixth or seventh aspect, the first code and the second code are formed on a same image forming medium.

According to a ninth aspect, in the information processing apparatus of the eighth aspect, the first code is formed inside an area where the second code is formed.

According to a tenth aspect, in the information processing apparatus of any one of the sixth to ninth aspects, the second code is formed in a color having reduced visibility under invisible light compared to visible light.

According to an eleventh aspect, an information processing apparatus that is capable of communicating with a terminal apparatus via a network includes a memory control unit and a content transmission unit. The memory control unit stores, in a memory or storage device, historical information related to first communication originating from the terminal apparatus and based on first connection information. The content transmission unit transmits a first content specified by the first connection information in response to the first communication originating from the terminal apparatus and based on the first connection information, and transmits, based on the historical information, either a second content or a third content different from the first content and the second content to the terminal apparatus in response to second communication originating from the terminal apparatus and based on second connection information.

According to a twelfth aspect, an image forming apparatus includes an image forming device that forms a first code and a second code on a same image forming medium. The first code is visible under invisible light, whereas the second code is visible under visible light. The first code is formed inside an area where the second code is formed.

According to a thirteenth aspect, in the image forming apparatus of the twelfth aspect, the second code is formed in a color having reduced visibility under the invisible light compared to the visible light.

According to a fourteenth aspect, an information processing system includes the information processing apparatus of any one of the first to eleventh aspects, the image forming apparatus of the twelfth or thirteenth aspect, and a terminal apparatus that is capable of communicating with the information processing apparatus via a network.

According to a fifteenth aspect, a method executed for providing content by an information processing apparatus, which is capable of communicating with a terminal apparatus via a network, includes storing, in a memory or storage device, historical information related to first communication originating from the terminal apparatus and based on first connection information, and transmitting, based on the historical information, either a first content specified by the first connection information or a second content specified by second connection information to the terminal apparatus in response to second communication based on the second connection information.

According to a sixteenth aspect, a program for causing an information processing apparatus that is capable of communicating with a terminal apparatus via a network to execute storing, in a memory or storage device, historical information related to first communication originating from the terminal apparatus and based on first connection information, and transmitting, based on the historical information, either a first content specified by the first connection information or a second content specified by second connection information to the terminal apparatus in response to second communication based on the second connection information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disk (DVD), and/or the memory of an FPGA or ASIC.

1. An information processing apparatus, comprising circuitry configured to:
store, in a memory, historical information related to first communication originating from a terminal apparatus and based on first connection information; and
transmit, based on the historical information, either a first content specified by the first connection information or a second content specified by second connection information to the terminal apparatus in response to second communication originating from the terminal apparatus and based on the second connection information.

2. The information processing apparatus according to claim 1, wherein the circuitry is configured to:
transmit the second content in response to the second communication when the historical information indicates that the first communication is not established; and
transmit the first content in response to the second communication when the historical information indicates that the first communication is established.

3. The information processing apparatus according to claim 1, wherein
the first connection information and the second connection information are associated with user information related to a user who operates the terminal apparatus, and
the circuitry is configured to store the historical information for each user identified by the user information.

4. The information processing apparatus according to claim 1, wherein the circuitry is configured to transmit the second content in response to the first communication originating from the terminal apparatus and based on the first connection information, the first communication being received before a predetermined date and time.

5. The information processing apparatus according to claim 1, wherein the circuitry is configured to:
request input of authentication information in response to the first communication originating from the terminal apparatus and based on the first connection information; and
transmit the first content specified by the first connection information based on a result of the input.

6. The information processing apparatus according to claim 1, wherein
the first communication is initiated by the terminal apparatus reading a first code including the first connection information, and
the second communication is initiated by the terminal apparatus reading a second code including the second connection information.

7. The information processing apparatus according to claim 6, wherein
the first code is an invisible image visible under invisible light, and
the second code is a visible image visible under visible light.

8. The information processing apparatus according to claim 6, wherein the first code and the second code are formed on a same image forming medium.

9. The information processing apparatus according to claim 8, wherein the first code is formed inside an area where the second code is formed.

10. The information processing apparatus according to claim 6, wherein the second code is formed in a color having reduced visibility under invisible light compared to visible light.

11. An information processing apparatus, comprising circuitry configured to:
store, in a memory, historical information related to first communication originating from a terminal apparatus and based on first connection information;
transmit a first content specified by the first connection information in response to the first communication originating from the terminal apparatus and based on the first connection information; and
transmit, based on the historical information, either a second content or a third content different from the first content and the second content to the terminal apparatus in response to second communication originating from the terminal apparatus and based on second connection information.

12. An image forming apparatus, comprising an image forming device to form a first code visible under invisible light and a second code visible under visible light on a same image forming medium,
the first code being inside an area where the second code is formed.

13. The image forming apparatus according to claim 12, wherein the second code is formed in a color having reduced visibility under the invisible light compared to the visible light.
